(19) United States
(12) Patent Application Publication
(10) Pub. No.: US 2025/0342176 A1
(43) Pub. Date: Nov. 6, 2025

(54) DATA PROCESSING METHOD AND SYSTEM FOR ITERATIVE SENSOR FUSION, COMPUTER PROGRAM PRODUCT AND COMPUTER READABLE MEDIUM FOR IMPLEMENTING THE METHOD

(71) Applicant: Commsignia Kft., Attala (HU)

(72) Inventors: Balázs Tóth, Dunaharaszti (HU); Gergely György Regula, Budapest (HU); András Váradi, Budapest (HU)

(21) Appl. No.: 18/860,842

(22) PCT Filed: Apr. 26, 2023
(86) PCT No.: PCT/HU2023/050022

§ 371 Date: Oct. 28, 2024

(30) Foreign Application Priority Data
Apr. 26, 2022 (HU) P2200131

(51) Int. Cl. G06F 16/28; G06F 16/2455

(52) U.S. Cl. CPC G06F 16/285; G06F 16/24552

(57) ABSTRACT

The invention relates to a data processing method for iterative sensor fusion. The method comprises receiving sensor data from a first data source type and a second data source type. The first data source type is adapted for providing sensor data for exclusively determining an entity and the second data source type is adapted for providing sensor data of a tracked entity. The method further comprises generating a data source identifier for each of the sensor data. The data source identifier comprises a data source type identifier corresponding to a data source type from which the sensor data is received. A first data source type identifier corresponds to the first data source type and a second data source type identifier corresponds to the second data source type. The method further comprises compiling a dataset that comprises newest sensor data received, and iteratively performing a data association step on the dataset.

### TECHNICAL FIELD

The invention relates to a data processing method and system for iterative sensor fusion. The invention relates also to a computer program product and computer readable medium implementing the method.

Vehicle-to-everything (V2X) technology allows entities participating in ground transport to share and receive various types of information in a distributed manner preferably via standardised message formats in real-time over dedicated radio channels. These pieces of information may include, e.g., the type of the sender device (a device of a sharing entity), absolute location, dimensions, heading, speed and other main properties. V2X messages may also contain confidence values for some of the information shared. V2X messages are digitally signed, and signers also send certificates proving their authentication. Next generation systems can also be able to send information about external objects and entities, such as non-connected vehicles, pedestrians, animals, etc. by broadcasting their onboard sensor output. Each perceived entity is represented by similar data then previously listed. The main objective of the technology is to enhance traffic safety. In recent times, the penetration of V2X-enabled devices has dynamically increased and the rate of the spread of technology is expected to further increase. The final aim is to integrate each relevant participant, including pedestrians, cyclists, or e-scooter users.

Two main directions have started to evolve that dramatically increase the amount of shared information within a V2X ecosystem. First, the percentage of V2X-enabled participants has continuously increased in the past few years as car manufacturers have started making V2X an integral part of their newest models. However, as most of the participants in transport are equipped with V2X technology, there tends to be a growing demand of integrating non-V2X entities, especially in areas where, according to the statistics, the traffic is more dangerous than the average.

To achieve this objective, an increasing number of roadside units (RSUs) have started to be equipped with smart sensors that usually perform object detection and tracking as well, which can serve as an input to dedicated sensor sharing messages (e.g., Collective Perception Message in European and Sensor Data Sharing Message in the US regions). Furthermore, as most vehicles are equipped with several sensors having various safety functions, their detections may also be shared within these standardised messages, providing a receiving V2X participant with an enormous amount of information.

This growing amount of information needs to be processed on the receiver side and this is where sensor fusion plays a crucial role. Sensor fusion is responsible for maintaining a local dynamic map, i.e., keeping track of entities (creating and deleting entities), associating the measurements with each other, and estimating entity states based on the measurements belonging to each entity. In a V2X environment, the problem is likely to grow to keeping track of hundreds of entities (vehicles, pedestrians, cyclists), which requires efficient processing methods.

### BACKGROUND ART

The technical field of sensor fusion has abundant literature resources, addressing various emerging challenging problems. In order to enhance safe operation of vehicles, in the technical field of autonomous or self-driving vehicles sensor fusion is routinely applied to combine the measurements of different sensors. An example of that is shown in US 2019/0351899 A1.

Most state-of-the-art data association methods perform their task on a probabilistic basis, i.e., a probability value is calculated to describe how likely it is that a measurement belongs to a specific entity and it is intended to find an optimal global solution over the entire measurement and entity set. In complex situations, several possibilities with various likelihoods exist and therefore, the required calculations may explode.

There are several methods and schemes elaborated for data association, information fusion, track initialisation and maintenance known in the art. Among the simpler information fusion algorithms, nearest or strongest neighbour methods have gained high popularity. They select several measurements and continue calculating with them but may tend to lose useful information in the future. In the general case when little or no assumptions can be made on the characteristics of the input data, several methods exist that outperform these methods in terms of stability and accuracy.

In contrast to proximity-based algorithms, probabilistic methods assign measurements weight based on the likelihood they belong to a given track instead. Those with low likelihood are used as track initialisers and those reaching a high enough over the time are confirmed. These methods are called probabilistic data association (PDA) methods. The result of these methods serves as a weighted input for an object tracking algorithm, e.g., a Kalman Filter (KF), an Extended Kalman Filter (EKF) or an Unscented Kalman Filter (UKF) that will provide the estimated states together with the corresponding covariances. Such a method is described in Y. Bar-Shalom et al., “The probabilistic data association filter,” in IEEE Control Systems Magazine, vol. 29, no. 6, pp. 82-100 (2009).

These compound methods are called probabilistic data association filters (PDAFs) and have several variants based on the preliminary assumptions on the detection characteristics and the numbers of objects to be tracked, see T. E. Fortmann et al., “Multi-target tracking using joint probabilistic data association,” in 19th IEEE Conference on Decision and Control including the Symposium on Adaptive Processes, Albuquerque, NM, USA (1980). One of the compound methods is the joint PDAF (JPDAF) for multiple object tracking, in which it is assumed that at maximum one measurement may originate from a real object (i.e., a measurement is otherwise a false measurement or clutter) and every single measurement may belong to several tracks and the possible associations are thus enumerated and weights are calculated for each one.

Another approach is the multiple-detection PDAF (MD-PDAF) family, see for example B. K. Habtemariam et al., “Multiple Detection Probabilistic Data Association filter for multistatic target tracking,” in 14th International Conference on Information Fusion, Chicago, IL, pp. 1-6 (2011) and B. Habtemariam et al., “A Multiple-Detection Joint Probabilistic Data Association Filter,” in IEEE Journal of Selected Topics in Signal Processing, vol. 7, no. 3, pp. 461-471, (2013). These approaches allow several measurements to originate from an object within the scope of a single sensor. The advantage over the base method is that a higher (more realistic) likelihood will be associated with those measurements that are supposed to originate from a target in each possible association. The drawback is the increased number of possible cases.

An alternative to the approaches above is called probabilistic hypothesis density (PHD) filtering and multiple hypothesis tracking (MHT), and it is disclosed in Kusha Panta et al., “Probability hypothesis density filter versus multiple hypothesis tracking,” in Proc. SPIE 5429, Signal Processing, Sensor Fusion, and Target Recognition XIII (2004). The probability hypothesis density filter is a practical alternative to the optimal Bayesian multi-target filter based on finite set statistics. It propagates only the first order moment instead of the full multi-target posterior. Recently, a sequential Monte Carlo (SMC) implementation of PHD filter has been used in multi-target filtering with promising results.

Samuel S. Blackman, “Multiple hypothesis tracking for multiple target tracking.” IEEE Aerospace and Electronic Systems Magazine 19.1, pp. 807-812 (2004) discloses a further group of methods called Multiple Hypothesis Tracking (MHT), a track-hypothesis tree is constructed whose branches represent possible data association results (track hypotheses). The probability of a track hypothesis is computed by evaluating the quality of data association results the branch had. To keep the method tractable, the hypothesis tree needs to be pruned, i.e., branches with low priority need to be removed using certain heuristics.

US 2021/0101612 A1 discloses a system for providing local dynamic map (LDM) data, wherein various bits of information, including external information received via wireless communication channels are used for a sensor fusion. The process according to US 2021/0101612 A1 includes receiving data from vehicles, mobile devices and other data sources (such as RSUs) and also determining from the received data whether any information should be integrated into the LDM data model. The process can also include determining a trust metric for a received data, and the data is only used if its trust metric is above a trust metric threshold.

US 2022/0159425 A1 discloses methods and apparatuses for determining and receiving V2X messages. The messages contain a sequence of information, and a part of this information can be related to sensor data. A quality indicator and/or an accuracy indicator can also be part of the V2X message.

US 2022/0272626 A1 discloses methods, systems and devices for wireless communications that support power efficient iterative sensor fusion. Sensing data is transformed both from vehicles to RSUs and from RSUs to vehicles.

US 2020/0228946 A1 discloses a device and method for V2X communication having various data elements (DE) and/or data frames (DF) that are summarized in Tables 1-3 of the document. Sensor IDs and Object IDs are used in the communication, wherein the Object IDs are unique identifiers assigned to the tracked objects, and the Object IDs are maintained as long as the object is tracked.

In view of the known approaches, there is a need for a data processing method that reduces the computational needs of associating various sensor data originating from different data sources, therefore it allows for a real-time data association and sensor fusion.

### DESCRIPTION OF THE INVENTION

The primary object of the invention is to provide a data processing method for iterative sensor fusion, which is free of the disadvantages of prior art approaches to the greatest possible extent.

As it is indicated above, most of the known methods are require a high computational capacity, especially if information is received from multiple data sources, i.e., from various types of sensors through different communication channels.

A further object of the invention is to provide a data processing method and system that allows for data association of sensor data originating from various different sources, wherein the data association is performed real-time.

Furthermore, the object of the invention is to provide a non-transitory computer program product for implementing the steps of the method according to the invention on one or more computers and a non-transitory computer readable medium comprising instructions for carrying out the steps of the method on one or more computers.

The objects of the invention can be achieved by the method according to claim 1. The objects of the invention can be further achieved by the system according to claim 12, the non-transitory computer program product according to claim 17, and by the non-transitory computer readable medium according to claim 18. Preferred embodiments of the invention are defined in the dependent claims.

An advantage of the method according to the invention is that it reduces the computational needs by reducing the number of possible associations needed to assign each and every sensor data to an entity. It has been recognized that certain types of data sources, such as a V2X message containing sensor data, definitively and exclusively belong to a single entity, and different information shared by a different instant of the same type of data source shall belong to a different entity. Therefore, information received e.g., from different V2X entities does not need to be matched against each other as it is a priori known that these pieces of information belong to a different entity, therefore computing capacity can be saved by not matching these pieces of information with each other.

A further advantage of the method according to the invention is that if a piece of sensor information has already been assigned to an entity, this information does not need to be matched with any other data or entities, which also reduces the total number of possible combinations, therefore reduces the computing capabilities.

It has been also recognized that characteristics of certain types of data sources such as smart sensors, i.e., sensors that are able to track an entity can also be utilized to reduce the computational needs of the method according to the invention. In certain embodiments of the method, results of a previous data association are saved and can be reused in a further iteration cycle, because if sensor data originating from such a data source has already been matched with an entity, it is very likely that such an association is still valid, therefore it is enough to check the validity of previous associations and only associating any further sensor data, which further reduces the computational needs of the method as less pieces of information needs to be matched against each other.

In certain embodiments of the method according to the invention, assigning identifiers based on the origin of an information can further be used to reduce the number of possible associations.

### BRIEF DESCRIPTION OF THE DRAWINGS

Preferred embodiments of the invention are described below by way of example with reference to the following drawings, where

FIG. 1 is a block diagram of a preferred embodiment of the system according to the invention,

FIG. 2 shows a preferred way to generate identifiers according to an embodiment of the method according to the invention,

FIGS. 3-9 show an exemplary implementation of an embodiment of the method according to the invention, and

FIG. 10 shows an exemplary use case of the method according to the invention.

### MODES FOR CARRYING OUT THE INVENTION

The invention relates to a data processing method for iterative sensor fusion, which is implemented by a computer system. The data processing method according to the invention comprises a step of receiving sensor data from at least a first data source type and a second data source type, wherein the first data source type is adapted for providing sensor data exclusively determining an entity and the second data source type is adapted for providing sensor data of a tracked entity. Preferably, the first data source type is a V2X message containing sensor data, and the second data source type is a smart sensor.

The data processing method according to the invention further comprises a step of generating, by a data adaptation module, a data source identifier for each of the sensor data, wherein the data source identifier comprises a data source type identifier corresponding to a data source type from which the sensor data is received, wherein a first data source type identifier corresponds to the first data source type and a second data source type identifier corresponds to the second data source type.

In certain preferred embodiments of the invention, sensor data from a third data source type can also be received, wherein the third data source type is preferably a conventional sensor that is not adapted to track an entity; thus, it can only provide individual measurement data that needs to be associated with an entity.

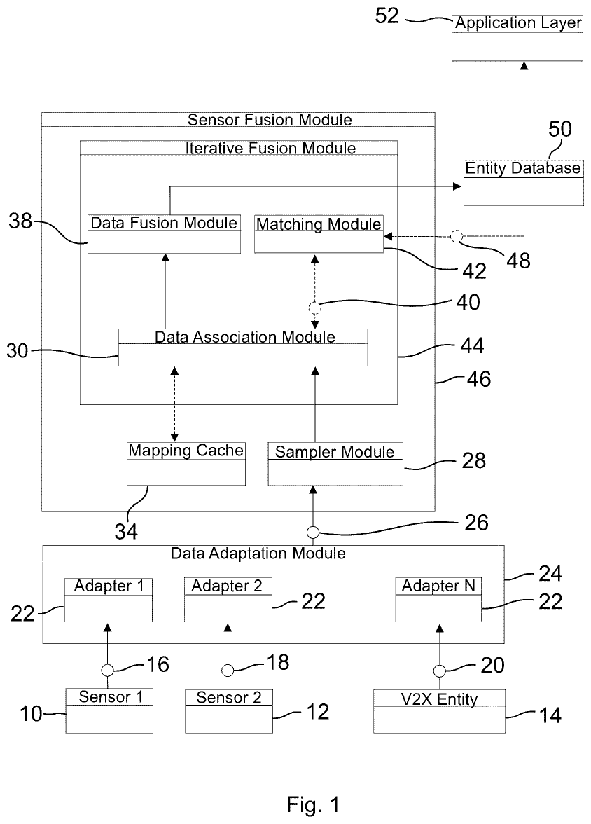

The data processing method according to the invention further comprises a step of compiling, in a sampling step, a dataset to be associated comprising as elements newest sensor data received. Preferably, the sampling step is implemented by a sampling module (see FIG. 1). In the sampling step, the newest, most up-to-date sensor data is collected from any data source. As a result, some of the intermittent data of a sensor having a more frequent sampling frequency can be omitted. This also reduces the computational needs of the method and also ensures that only the most relevant, up-to-date sensor data is dealt with.

The data processing method according to the invention further comprises a data association step comprising the step of generating an entity selection set. The entity selection set is generated to collect all the available sensor data about an entity, and a dedicated sensor selection set is generated for each entity from which sensor data is received about.

The process of generating the entity selection set comprises the step of selecting an element of the dataset to be associated having the first data source type identifier and moving it to the entity selection set. The process of generating the entity selection set further comprises the step of matching said element of the dataset having the first data source type identifier with each element of the dataset having the second data source type identifier, and selecting each one of the elements of the dataset having the second data source type identifier that matches a same entity as said element of the dataset having the first data source type identifier, and moving each selected elements of the dataset into the entity selection set. By this process, each sensor data in the dataset to be associated will be collected that belongs to a same (i.e., a first) entity.

The data processing method according to the invention further comprises a step of iteratively performing the data association step until the dataset has no more element having the first data source type identifier, i.e., a different entity selection set is created for each individual entity. The method according to the invention utilizes the characteristics of the first data source type, namely, that sensor data provided by this data source type exclusively determines an entity, i.e., sensor data received from different data sources of the first data source type belong to different entities. Therefore, it is not necessary to match them against each other, but these sensor data can be included in different entity selection sets.

The data processing method according to the invention also comprises a step of matching remaining elements of the dataset having the second data source type identifier with each other and forming group(s) of elements of the dataset, wherein each group belongs to a same entity. This step ensures that even if no sensor data is received about an entity from a first data source type, one or more sensor data can relate to said entity and these sensor data need to be associated with each other.

Preferably, the method according to the invention further comprises a step of storing the entity selection set in a mapping cache. Even more preferably, each entity selection set is stored in the mapping cache. Furthermore, the group(s) of elements of the dataset are preferably also stored in the mapping cache, especially if said group contains at least two elements, i.e., an association is made between at least two elements of the dataset to be associated. Information stored in the mapping cache can be used in further processing steps, e.g., when a further dataset to be associated is generated. Preferred implementation of said further processing steps are described below in more detail.

Preferably, the method according to the invention further comprises the steps of compiling a further dataset to be associated comprising as elements newest sensor data received. When a further dataset to be associated is compiled, the mapping cache can be consulted to check whether a previous association exist between elements of the further dataset to be associated. This is preferably performed by the following steps:
selecting an element of the further dataset to be associated having the first data source type identifier and moving it to the entity selection set,
checking whether the mapping cache includes an element of the dataset to be associated having the first data source type identifier, and if an element of the dataset to be associated having the first data source type identifier is included in the mapping cache, adding the corresponding elements of the dataset having a second data source type identifier to the corresponding entity selection set,
performing the data association step for the remaining elements of the further dataset to be associated, and
updating the mapping cache with the entity selection set.

The above steps can ensure that the mapping cache is always up-to-date, and that the least amount of association steps is performed, thus the computational needs of the method is reduced.

In a preferred implementation of the method according to the invention the method further comprises a sensor fusion step, by a sensor fusion module, for combining sensor data of the entity selection set.

The sensor data provided by any of the data sources is preferably a position data of an entity, a dynamical data of an entity, motion data or a dimension data of an entity, or an entity type. Even more preferably, the sensor data can include a confidence interval, e.g., a position data of an entity can include an uncertainty of said position data to further aid the data association process.

The method according to the invention preferably further comprises a step of storing the entity selection set in an entity database. The entity database is preferably accessible by other modules or applications that need to use data about an entity.

Preferably, the method according to invention is adapted to be able to receive sensor data from a third data source type, e.g., conventional sensors that are not able to track an entity, therefore each sensor data provided by a third data source type needs to be associated in each occurrence. This preferred embodiment of the method comprises a step of generating a data source identifier including a third data source type identifier for each of the sensor data received from the third data source type, and including sensor data having the third data source type identifier in the dataset to be associated. The method preferably further comprises a step of generating an extended entity selection set, and in the in the data association step, preferably said element of the dataset having the first data source type identifier is matched with each element of the dataset having the third data source type identifier, and each one of the elements of the dataset having the third data source type identifier is selected that matches the same entity as said element of the dataset having the first data source type identifier, and moving each selected elements of the dataset into the extended entity selection set.

Preferably, sensor data having the third data source type identifier is not stored in the mapping cache, because it cannot be ensured that new measurements provided by the same sensor correspond to the same entity as a previous measurement. Therefore, even if an association has been made between sensor data having the third data source type identifier and sensor data having either the first or the second data source type identifier, such an information cannot be used in an other data association step.

The method according to the invention can further comprise a step of storing the entity selection set and the extended entity selection set in the entity database.

Preferably, the method according to the invention further comprises a step of creating a unified sensor data by the data adaptation module 24. This step can help not only the data association, but also a possible sensor fusion, because sensor data having a unified format can be compared and/or fused more easily.

The method according to the invention preferably further comprises a step of determining a trust score for each data source from which sensor data is received. More details are discussed in connection with FIG. 10.

FIG. 1 shows a preferred embodiment of a data processing system according to the invention which is also suitable to perform the steps of the data processing method according to the invention.

The system comprises a data association module 30 that is adapted to perform data association of sensor data received from different data sources. Possible data sources can include a first data source type, such as a V2X entity 14 that can share a V2X message 20 (e.g., a CAM or a BSM message) including sensor data, a second data source type, such as a smart sensor 12 that can preferably provide tracked sensor data 18 as a sensor data, and a third data source type, such as a conventional sensor 10 that can provide conventional sensor data 16 as a sensor data. In certain embodiments of the system, the number of different data source types can vary. Furthermore, the system is preferably adapted to receive sensor data from multiple instances of the same data source type.

Sensor data originating from different data sources are fed into a respective adapter 22, wherein the adapters 22 can be a part of a data adaptation module 24. An adapter 22 is preferably adapted to provide a uniform data representation of the different data sources. The advantage of this is that a uniform data can be processed more easily by other modules of the system.

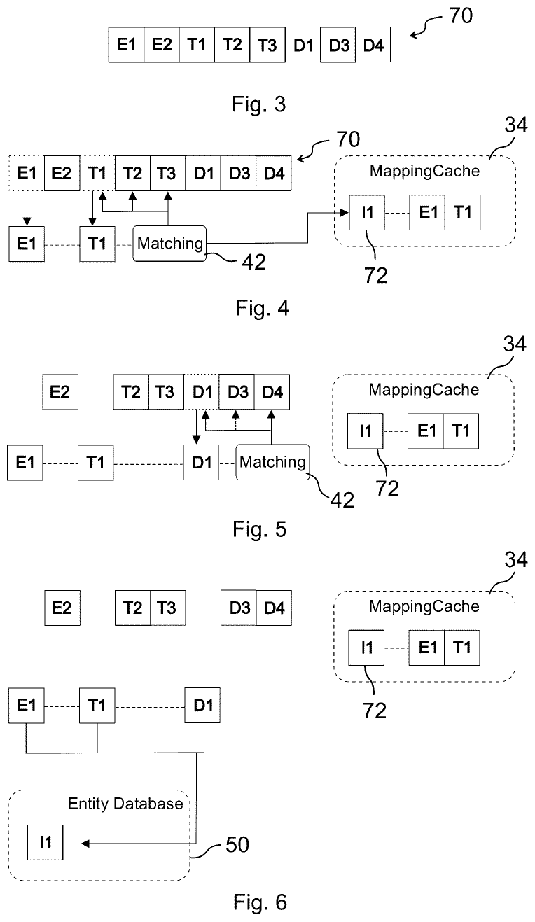

The data association module 30 receives entity data elements 26 from the adapters 22 or the data adaptation module 24, wherein the entity data elements 26 need to be associated by the data association module 30, i.e., entity data elements 26 belonging to the same entity needs to be found. Preferably, the entity data elements 26 are compiled into a dataset 70 to be associated (see FIG. 3). The dataset 70 to be associated can be compiled by the data association module 30 or by a sampler module 28. The sampler module 28 preferably creates an ordered dataset 70.

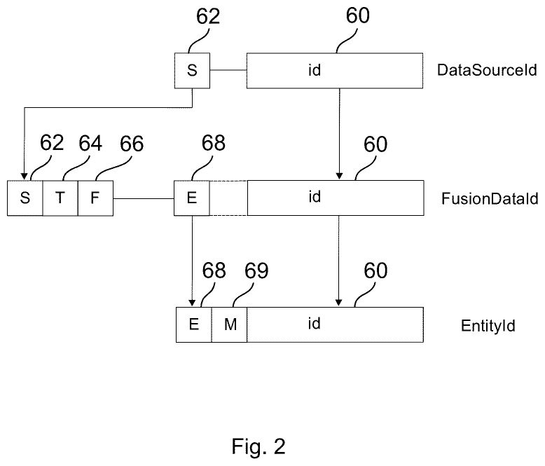

Preferably, the data adaptation module 24 preferably assigns data source identifiers of each entity data element 26, and the sampler module 28 further assigns fusion data identifiers to them to aid the data association and/or sensor fusion process. Preferably, the sampler module 28 creates the ordered dataset 70 based on the data source identifiers. More details of the identifiers are discussed in connection with FIG. 2.

The data association module 30 preferably performs the data association step according to the data association method of the invention. The system preferably comprises a mapping cache 34 that is adapted to store sensor data associated to an entity. The mapping cache 34 is preferably in a bidirectional communication connection with the data association module 30 to store already associated data arranged by entities and to let the data association module 30 to check whether an association already exist between sensor data, i.e., between elements of the dataset 70 to be associated. If an association already exists, it can speed up the association process and reduce the computational needs by reducing the number of possible associations. Preferably, the data association module 30 generates

The system preferably comprises a matching module 42 that is in a bidirectional communication connection with the data association module 30. The matching module 42 is preferably adapted to receive a pair of sensor data to be matched and to return a matching probability 40 to the data association module 30. Based on the matching probability, the data association module 30 can decide whether the pair of sensor data belongs to the same entity or not. If the pair of sensor data probably belongs to the same entity, it can be saved in an entity database 50 or in the mapping cache 34, furthermore, said pair of sensor data can be forwarded to a data fusion module 38 that is adapted to perform a sensor fusion. If the pair of sensor data can already be found in the mapping cache 34, the mapping cache 34 can be updated. Even more preferably, the data fusion module 38 receives all the relevant (associated) sensor data belonging to the same entity, and sensor fusion is performed for an entity all at once. The data fusion module 38 preferably creates a fused data for an entity, which can be stored in the entity database 50.

Preferably, data stored in the entity database 50 can be used by any applications in an application layer 52. A possible application in the application layer can be a filtering or safety application. An example of it is described in more detail in connection with FIG. 10 below.

The entity database 50 preferably provides the matching module 42 with information about a previous entity state 48 of an entity, by the help of which more accurate matching can be performed.

Preferably, the system comprises an iterative fusion module 44 that includes the data association module 30, the data fusion module 38 and/or the matching module 42. The system according to the invention preferably further comprises a sensor fusion module 46 that preferably includes the iterative fusion module 44, the sampler module 28 and/the mapping cache 34.

According to the preferred example of the system according to the invention, the direction of the data flow is indicated by arrows. In other embodiments of the system, further communication or data channels can exist between the elements, modules of the system.

In order to aid the data association method according to the invention, each received sensor data, i.e., any measurements belonging to entities are labelled by identifiers that are more complex structures than just a unique integer value. A preferred structure of various identifiers used at different processing stages of certain embodiments of the method according to the invention are shown in FIG. 2.

When a new measurement (i.e., sensor data) is injected into the system according to the invention, a data source identifier (DataSourceId) is generated and it is assigned to said measurement. The data source identifier, preferably comprises a numeric identifier number 60 (or a label) that preferably indicates what kind of entity (e.g., an object or traffic information) said measurement describes. The data source identifier preferably further comprises a data source type identifier 62 that is denoted by S in FIG. 2. The data source type identifier 62 corresponds to a data source type that the measurement is originating from. As an example, preferably two or three different data source types can be defined and used based on the characteristics of the sensors. Preferably, the following two data source types can be defined.

First data source type. Data sources belonging to the first data source type can exclusively determine an entity. Therefore, sensor data originating from different data sources of the first data source type describe different entities, while sensor data originating from a same data source of the first data source type are expected to describe properties of the same entity. The first data source type can also be called the “exact” type, as such sensor data exactly corresponds to an entity. In FIGS. 3-9 letter ‘E’ denotes sensor data having a first data source type identifier. An example of the first data source type is a V2X message containing sensor data. The V2X message is preferably a CAM or a BSM message. Preferably, different message types can be processed by different adapters 22. Accordingly, when a measurement (sensor data) is received via a V2X message, a first data source type identifier will be assigned to it. V2X messages typically comprise a unique identifier (a numeric identifier number 60) that can also be used for generating the data source identifier. The unique identifier can be a 48-bit identifier.

A special case of the first data source type can be an ego-entity. The ego-entity is usually built up of local measurements, e.g., GNSS or more accurate localisation information and measurements retrieved from on-board electronics, for example in case of an ego-vehicle, the origin of the sensor data can be the vehicle's CAN network.

Second data source type. Data sources belonging to the second data source type are able to track an entity, i.e., taking multiple measurements on a same entity. The second data source type can also be called the “tracked” type, as such a data source can track an entity. Therefore, in FIGS. 3-9 letter ‘T’ denotes sensor data having a second data source type identifier. Typically, measurements provided by smart sensors will be assigned a second data source type identifier.

Alternatively, a V2X message can also provide “tracked” type sensor data. For example, sensor data received via a CPM ‘perception’ message (according to the EU regional standards) and a SDSM ‘sensor data sharing’ message (according to the US standards). These V2X messages share sensor data of own sensors to other ITS participants. The content of these received V2X messages is assigned the second data source type identifier, just like the sensor data of an own sensor on the receiver side.

If sensor data is received from any other data sources a third data source type identifier can be assigned to it.

Third data source type. Sensor data received from a data source that cannot ensure that its data exclusively belongs to an entity, and tracking of an entity is also not possible by said data source, a third data source type identifier is to be assigned to such sensor data. As an example, sensor data received from a conventional sensor (not a smart sensor) can be assigned a third data source type identifier. The third data source type can also be called the “dummy” type; in FIGS. 3-9 letter ‘D’ denotes sensor data having a third data source type identifier. Preferably, sensor data having a third data source type identifier is not to be stored in the mapping cache, because due to the lack of tracking, it cannot be ensured that consecutive measurement originating from the same sensor relates to the same entity. For this reason, any sensor data having the third data source type identifier needs to be matched with sensor data having a first data source type identifier and/or a second data source type identifier, and also with other sensor data having the third data source type identifier.

Preferably, the data source identifier is assigned to the sensor data by a data adaptation module 24 (see FIG. 1).

When a dataset to be associated is compiled, preferably by a sampling module 28, the information contained in the data source identifier can be extended, preferably by adding a registration key (or a feed identifier 66) of an adapter 22 that pushed the measurement (sensor data) into a sensor fusion module 46 of the system according to the invention. In cases when it is known that multiple adapters 22 process information originating from the same entity, e.g., motion data and dimension data of the same entity is processed by different adapters 22, a tracking identifier 64 can be added to the data source identifier. The same tracking identifier 64 is to be assigned to sensor data originating from the same entity, therefore the tracking identifier 64 can be used to aid and expedite the data association process.

Furthermore, an entity type flag 68 can also be added to the data source identifier. The entity type flags 68 can be used for determining a final data entry type in the entity database 50. As an example, different entity type flags 68 can provide categories such as an object, an intersection, a road information, etc. The entity type flag 68 can also help to the data association step, because a sensor data having an intersection type of entity type flag 68 does not need to be matched with a sensor data having a road information type of entity type flag 68. Preferably, only sensor data having an object type of entity type flag 68 need to be fused, other categories, e.g., an intersection or a road information type, do not need to be included in a sensor fusion, therefore such sensor data can be moved directly to the entity database 50 after data association.

Such an extended data source identifier can be called a fusion data identifier (FusionDataId) which contains further information relevant for purposes such as data fusion. Preferably, the fusion data identifier is generated by the sampling module 28.

Preferably, fusion data identifiers are also stored in the mapping cache 34 to make the next processing cycle of the data association easier and more effective.

After the data association step and/or a sensor fusion step, an entity identifier can be generated for each entity. When sensor data relating to the entity is stored in an entity database 50, the entity identifier can also be stored therewith.

Preferably, the entity identifier is transformed from a data source identifier having a numeric identifier number 60 (from a V2X message), or in other cases, the entity identifier is assigned by an iterative data association module 30. In case of the entity identifier is generated by the iterative data association module 30, a modifier flag 69 can be set, denoting that this entity is ‘virtual’, i.e., the entity has no sensor data having the first data source identifier. The entity identifier is preferably a unique identifier that can be used to distinguish entities stored in the entity database 50. The entity identifier therefore can be used by any applications stored in the application layer 52.

The data source type identifier 62, the tracking identifier 64 and/or the feed identifier 66 is typically used for data association and/or sensor fusion, thus it is not necessary to include them in the entity identifier, because it is very unlikely that an application can make use of the information carried by them. However, it is preferred to include the entity type flag 68 in the entity identifier, because other application can benefit from knowing the type of the entity stored in the entity database 50. The construction of the identifiers according to FIG. 2 helps the data association and/or sensor fusion processes to the greatest possible extent, while using the least amount of storage capacity.

FIGS. 3-9 illustrate steps of an exemplary implementation of the method according to the invention.

FIG. 3 shows an example of a dataset 70 to be associated that is preferably generated by a sampling module 28. The dataset 70 to be associated preferably contains newest sensor data received from one or more data sources. According to the example of FIG. 3, two elements of the dataset 70 have a first data source type identifier (“exact” type), three elements of the dataset 70 have a second data source type identifier (“tracked” type) and three elements of the dataset 70 have a third data source type identifier (“dummy” type). The elements of the dataset 70 to be associated are denoted by their individual fusion data identifiers, wherein the letters indicate the data source type identifier 62 (i.e., E—exact, T—tracked, D—dummy), and the numbers correspond to the tracking identifier 64. A feed identifier 66 was not included in the fusion data identifiers.

Preferably, the dataset 70 is ordered according to the data source type identifiers, i.e., the first elements are sensor data having the first data source type identifier, these are followed by elements that have the second data source type identifier, and finally the dataset 70 includes elements having the third data source type identifier. The ordering of the dataset 70 is preferably performed by the sampler module 28. The dataset 70 can be stored at a data cache.

FIG. 4 shows a first sub-step of the data association step. First, a sensor data having a first data source type identifier is selected, e.g., the one denoted by E1 in FIG. 4. Then, each of the elements of the dataset 70 having the second data source type identifier are checked to find sensor data describing the same entity (a same object) as the selected element E1. Preferably, the selected element E1 is matched with each one of the sensor data having the second data source type identifier (i.e., T1-T3). The matching is preferably performed by a matching module 42 (see FIG. 1), preferably based on statistical methods. According to the example of FIG. 4, out of the three elements having the second data source type identifier (T1-T3), only the one denoted by T1 corresponds to the same entity, hence it is selected and preferably stored alongside the selected element E1 in a mapping cache 34. In the mapping cache 34, an entity identifier 72 can be assigned to the selected sensor data. It is to be noted that more elements of the dataset 70 having the second data source type identifier can correspond to the same entity, therefore each of the elements of the dataset 70 having the second data source type identifier needs to be matched with the selected element E1. The number of matchings can be further reduced by the use of tracking identifiers 64. According to the example shown in FIG. 4, tracking identifiers 64 are included in the fusion data identifiers, wherein the same tracking identifier 64 correspond to the same entity, therefore, elements E1 and T1 can be immediately selected as matching sensor data. In similar cases, only elements not having a tracking identifier 64 needs to be matched with an element having a first data source type identifier.

A further step is shown in FIG. 5, wherein elements of the dataset 70 having the third data source type identifier (D1, D3, D4) are checked to find sensor data describing the same entity (same object) as the selected element E1. Preferably, this step is also performed by the matching module 42, wherein the matching module 42 preferably uses the same statistical method to select elements of the dataset 70 having the third data source type identifier that correspond to the same entity as the selected element E1. It is to be noted that even the element denoted by D1 has been selected as an element corresponding to the same entity as the selected element E1, it is preferably not stored in the mapping cache 34, because this type of association cannot be used in a further association cycle, therefore it is not necessary to store it in the mapping cache 34, but memory usage of the mapping cache 34 can be saved for storing data of other entities.

According to FIG. 6, it is preferred to store all the sensor data corresponding to the same entity I1 in an entity database 50, i.e., the entity database preferably contains sensor data having the third data source type identifier.

Due to the fact that elements of the dataset 70 to be associated has been moved to an entity selection set, the size of the dataset 70 is reduced (i.e., the dataset 70 contains less elements), therefore the number of possible combinations of the elements of the dataset 70 is also reduced that improves the performance the method according the invention by reducing the computational needs. Such a reduction makes it also possible to perform the method according to the invention on an on-board unit of a vehicle that usually has a limited computational capacity.

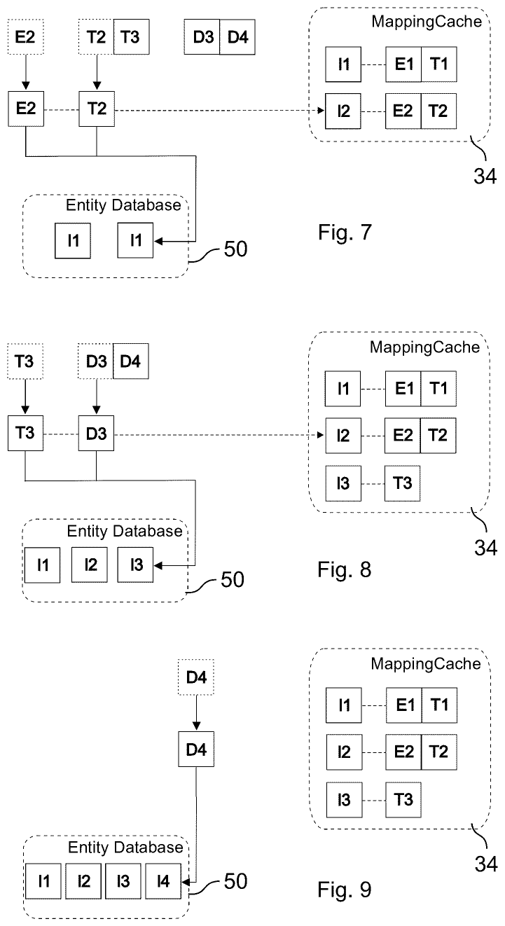

FIG. 7 represents a step of selecting an element of the dataset 70 that has a first data source type identifier (E2) and it is matched against the remaining elements having the second data source type identifier. According to the example shown in FIG. 7, only the element denoted by T2 matches the selected element E2, i.e., these two elements of the dataset 70 belong to the same entity I2. As already explained above, both elements denoted by E2 and T2 are saved in the mapping cache 34. According to FIG. 7, no element of the dataset 70 belong to the same entity I2, therefore only the elements denoted by E2 and T2 are saved in the entity database 50.

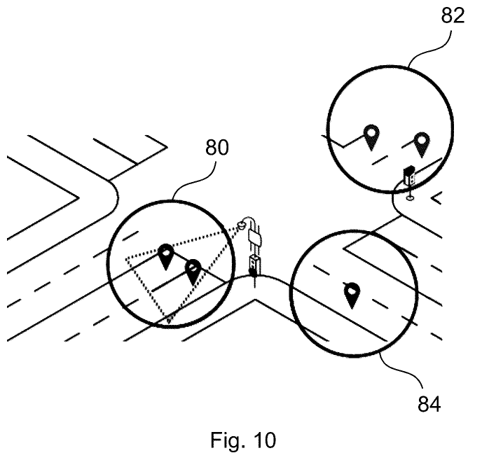

After the steps shown in FIG. 7, no more elements are left in the dataset that have the first data source type identifier; thus, FIG. 8 shows that the remaining elements of the dataset 70 are matched with each other, i.e., the remaining elements are grouped together, wherein each group corresponds to different entities. Only groups with elements having the second data source type identifier are stored in the mapping cache 34, however every group is saved in the entity database 50. As an example, FIG. 9 shows that a group only comprising elements having the third data source type identifier are also stored in the entity database 50.

After the steps shown in FIG. 9, there are no more elements left in the dataset 70, thus a further dataset can be compiled from the newest sensor data. In case, there are already associated entities in the mapping cache 34, elements of the further dataset can be looked up in the mapping cache 34, and if a previous association already exist, there is no need to perform a matching by the matching module, but the mapping cache 34 and the entity database 50 can be updated with the new sensor data. For elements of the further dataset that are not present in the mapping cache 34, the association step described above needs to be performed in a similar manner.

Preferably, matching of two elements of the dataset 70 to be associated and/or the further dataset is performed by a statistical check. E.g., sensor data can describe a motion of an entity, for example, in a form of a state vector, in which case the sensor data can comprise position, speed, and/or heading of the entity. Sensor data can also include estimated values and their accuracies.

When a possible piece of sensor data is found that might be added to a current set of measurement belonging to a same entity, preferably, a combined value is calculated which is a weighted average of sensor data of the current set of measurements and the possible piece of sensor data, and an accuracy is obtained by a covariance intersection method (e.g., by a two-dimensional covariance intersection method for a position and a one-dimensional covariance intersection method for a speed and a heading). Preferably, values of the position, the speed and the heading before and after adding (merging) a new piece of data are checked against each other and a similarity measure is derived from a ratio of an accuracy of the new piece of data and the combined data. If the similarity measure exceeds a threshold value, the merged state with the new piece of data is accepted and the iteration continues.

It is to be noted that other motion parameters such as acceleration, yaw rate etc. can also be a part of a state vector, however, these other motion parameters are typically not included in the decision process.

Preferably, elements of each entity selection set are fused together (preferably in a sensor fusion step) to provide an aggregated information about an entity. Once sensor data belonging to the same entity is updated, the sensor fusion step is to be performed again. It is to be noted that sensor fusion algorithms have an inherent property that in certain situations, wrong measurements can be combined. Such situations may occur when a difference between motion parameters of two entities is below a threshold value for a time period and thus such motion parameters are merged together as if they would belong to the same entity. However, in cases motion parameters of two entities considerably differ from each other, the sensor fusion shall react. For this reason, data association continuously needs to be checked and in case a false fusion is detected, data association should be reset. Preferably, during such a check, the same method is to be performed as in the sensor fusion step.

The result of the data association method according to the invention can be utilised by various application, e.g., it can support performing sensor fusion as it has been discussed above, and further filtering and/or safety applications.

An exemplary application is shown in FIG. 10. Preferably, the method according to the invention further comprises a step of assessing a data source providing sensor data. Preferably, the step of assessing a data source providing sensor data is performed individually for each data source.

Preferably, an indicator for a positive reliability and an indicator for a negative reliability is applied, wherein a reliability value is determined based on verification of the received sensor data with sensor data originating from a different, reliable data source. For example, an ego-vehicle can verify received data by comparing it with its own, trusted measurements. Furthermore, received sensor data can be cross-checked for inconsistencies and conformities.

If it is found that a data source provides malicious or incorrect data, e.g., a wrong position, a reliability value (or a trust score) of said data source needs to be lowered. Therefore, it is preferred that a new data source has an initial trust score, wherein the initial trust score is a predetermined value, which is not an extremum of the possible trust scores. Preferably the initial trust score is around a mid of the full range of the possible trust scores. For example, if the trust scores are ranged between 0 and 100, then it is preferred if the predetermined value of the trust score is around 50. It allows that sensor data originating from a new, previously unknown entity would be taken into account, because on the one hand missing an important piece of information (sensor data) could lead to an accident, an on the other hand fully trusting an unknown data source that possibly shares incorrect data can also be dangerous. Preferably, if it is found that information (e.g., sensor data) provided by an object or entity contained anomalies, its trust score value can be lowered (negative trust), or if it is found that other (preferably reliable) entities confirm or re-assure the accuracy of the provided information, the trust score value of such an object or entity can be increased (positive trust).

The main benefits of determining trust score values can be the following. Misbehaviour of a data source can be detected, preferably by a set of standardised and unique proprietary checks. A misbehaviour evidence or probability metrics can also be provided to safety applications which can use or ignore such information. Data sources that have been flagged (due to providing incorrect sensor data) can be filtered, therefore an amount of false positive safety application triggers can be greatly reduced. Misbehaviour detection can also identify fantom vehicles and other means of cyber security threats.

The trust score can be used by various applications as a filtering or triggering criteria, i.e., some pieces of information originating from a data source having a trust score below a predetermined threshold can be filtered out/omitted. The trust score (preferably a single value) can be added as metadata for each object or entity stored in a vehicles' environmental perception database or local dynamic map which is a fused single database representing the vehicles perception of its surrounding objects/entities.

Preferably, a vehicle continuously receives incoming V2X information and updates its own database (e.g., entity database 50) as described in connection with the data association method described above.

In a preferred embodiment the trust score is ranged from −100 to +100, wherein an initial trust score is zero. The initial trust score can be increase into a positive value (e.g., up to +100) or decreases into a negative value (e.g., until −100). The trust score preferably represents trust that an ego-vehicle has about a specific abstracted entity, and by trust it is aimed to represent a probability that information received from that entity is correct. Preferably, information represented by the trust score is not a confidence of a measurement (e.g., a position confidence or a positioning confidence), because a confidence has a clearly different goal and usage. As an example, a position confidence can also be fused according to fusion rules and it can be utilised to be part of a fused abstract object position confidence.

Preferably, a trust score corresponds to an abstracted entity (object), however, it is also preferred to assign a source trust score to each data source. A data source can be an ITS (Intelligent Transportation System) station or an individual sensor. Preferably, an initial source trust score can also be defined and assigned to each new data source that has not been assessed before. Preferably, the source trust score has a similar range as the trust score and the initial source trust score is preferably zero. Events or information that indicates that a particular data source cannot be trusted results in a decrease of the source trust score. Such events can be an identification of misbehaviour of an ITS station or otherwise inconsistent V2X data provided by said ITS station. An example of the latter can be incorrect dynamical data sent versus the measurement by the ego-vehicles' onboard sensors (e.g., a remote vehicle and the ego-vehicle are travelling close to each other, sensors report the same speed, and the ego-vehicle travels at 100 km/h, while the remote vehicle reports 50 km/h). Another example is inconsistency with other ITS stations, when one station reports confirmed emptiness of an area using a Free Space description of a Collective Perception Service, while another vehicle sends information about a vehicle being present in that area. In such cases, both ITS stations' source trust scores are to be decreased. An increase in the source trust score can be achieved by remaining consistent over time or by a confirmation of sent V2X data by the ego-vehicle's own sensors.

It is preferred if individual software modules or algorithms are able to alter the trust score and the source trust score by alternative/parallel methods. For calculating a final trust score for an entity, the source trust scores of the data sources providing information about said entity can be used. Preferably, the final trust score of the entity can be calculated by using the source trust scores as a weight when combining the individual pieces of information about the entity. E.g., misbehaviour indication about a station from an ITS station with a negative source trust score is to be considered with a lower weight. Another example is an increase of the trust score over time when multiple ITS stations confirm the existence of a vehicle, thus a remote vehicle which is being tracked by three other vehicles using the Collective Perception Service shall increase the vehicle's trust score compared to a case when only two vehicles keep reporting about it.

ADAS functions and applications may also consider the trust score at any moment in time to affect a weight of an information while fusing it with other data from different data sources (e.g., onboard sensors) and validating a trigger of an action based on that information (e.g., issuing warnings to a driver or making manoeuvre changes). Events based on calculations involving such objects, like proximity applications (e.g., Forward Collision Warning) shall trigger in more cases if an entity has a high trust score.

According to the example of FIG. 10, two vehicles that can share information about themselves with each other, and therefore validate the accuracy of the received information with their own measurements can be assigned a high trust score 80, it the shared information is successfully validated. As the exemplary scenario depicts, these two vehicles are also in a line-of-sight of a camera/traffic light, that can validate the information shared by the vehicles. In case a fantom vehicle misbehaviour can be detected, a low trust score 84 is assigned to the corresponding vehicle. For vehicles communicating via a secured CAM message, a neutral trust score 82 can be assigned; the neutral trust score 82 can later be either increased or decreased if more information is available about said vehicles and the sensor data provided by them.

The invention, furthermore, relates to a computer program product comprising instructions which, when the program is executed by a computer, cause the computer to carry out an embodiment of the method according to the invention.

The computer program product may be executable by one or more computers.

The invention also relates to a computer readable medium comprising instructions which, when executed by a computer, cause the computer to carry out an embodiment of the method according to the invention.

The computer readable medium may be a single one or comprise more separate pieces.

The invention is, of course, not limited to the preferred embodiments described in detail above, but further variants, modifications and developments are possible within the scope of protection determined by the claims. Furthermore, all embodiments that can be defined by any arbitrary dependent claim combination belong to the invention.

### LIST OF REFERENCE SIGNS

10 conventional sensor
12 smart sensor
14 V2X entity
16 conventional sensor data
18 tracked sensor data
20 V2X message
22 adapter
24 data adaptation module
26 entity data elements
28 sampler module
30 data association module
34 mapping cache
38 data fusion module
40 matching probability
42 matching module
44 iterative fusion module
46 sensor fusion module
48 previous entity state
50 entity database
52 application layer
60 numeric identifier number
62 data source type identifier
64 tracking identifier
66 feed identifier
68 entity type flag
69 modifier flag
70 dataset
72 entity identifier
80 high trust score
82 neutral trust score
84 low trust score

1. A data processing method for iterative sensor fusion with a computer system, the method comprising the steps of
receiving sensor data from at least a first data source type and a second data source type, wherein the first data source type is adapted for providing sensor data exclusively determining an entity and the second data source type is adapted for providing sensor data of a tracked entity,
generating, by a data adaptation module (24), a data source identifier for each of the sensor data, wherein the data source identifier comprises a data source type identifier corresponding to a data source type from which the sensor data is received, wherein a first data source type identifier corresponds to the first data source type and a second data source type identifier corresponds to the second data source type,
compiling, in a sampling step, a dataset to be associated comprising as elements newest sensor data received,
the method is characterized by
performing a data association step, by a data association module (30), comprising the step of generating an entity selection set by
selecting an element of the dataset (70) to be associated having the first data source type identifier and moving it to the entity selection set,
matching said element of the dataset (70) having the first data source type identifier with each element of the dataset (70) having the second data source type identifier, and
selecting each one of the elements of the dataset (70) having the second data source type identifier that matches a same entity as said element of the dataset (70) having the first data source type identifier, and moving each selected elements of the dataset (70) into the entity selection set,
iteratively performing the data association step until the dataset (70) has no more element having the first data source type identifier, and
matching remaining elements of the dataset (70) having the second data source type identifier with each other and forming group(s) of elements of the dataset (70), wherein each group belongs to a same entity.

2. The method according to claim 1, wherein the first data source type is a V2X message (20) containing sensor data, and the second data source type is a smart sensor (12).

3. The method according to claim 1, further comprising a step of storing the entity selection set in a mapping cache (34).

4. The method according to claim 3, further comprising the following steps
compiling a further dataset (70) to be associated comprising as elements newest sensor data received,
selecting an element of the further dataset (70) to be associated having the first data source type identifier and moving it to the entity selection set,
checking whether the mapping cache includes an element of the dataset (70) to be associated having the first data source type identifier, and if an element of the dataset (70) to be associated having the first data source type identifier is included in the mapping cache (34), adding the corresponding elements of the dataset (70) having a second data source type identifier to the corresponding entity selection set,
performing the data association step for the remaining elements of the further dataset (70) to be associated, and
updating the mapping cache (34) with the entity selection set.

5. The method according to claim 1, further comprising a sensor fusion step, by a data fusion module (38), for combining sensor data of the entity selection set.

6. The method according to claim 1, wherein sensor data is a position data of an entity, a dynamical data of an entity, a dimension data of an entity, or an object type.

7. The method according to claim 1, further comprising a step of storing the entity selection set in an entity database (50).

8. The method according to claim 1, characterized by
receiving sensor data from a third data source type,
generating a data source identifier including a third data source type identifier for each of the sensor data received from the third data source type,
including sensor data having the third data source type identifier in the dataset (70) to be associated,
generating an extended entity selection set,
in the data association step, matching said element of the dataset (70) having the first data source type identifier with each element of the dataset (70) having the third data source type identifier, and
selecting each one of the elements of the dataset (70) having the third data source type identifier that matches the same entity as said element of the dataset (70) having the first data source type identifier, and moving each selected elements of the dataset (70) into the extended entity selection set.

9. The method according to claim 8, further comprising a step of storing the entity selection set and the extended entity selection set in an entity database (50).

10. The method according to claim 1, further comprising a step of creating a unified sensor data by the data adaptation module (24).

11. The method according to claim 1, further comprising a step of determining a trust score for each data source from which sensor data is received.

12. A computer system adapted to perform the steps of the method according to claim 1, the system comprising
means for receiving sensor data from at least a first data source type and a second data source type, wherein the first data source type is adapted for providing sensor data exclusively determining an entity and the second data source type is adapted for providing sensor data of a tracked entity,
a data adaptation module (24) adapted to generate a data source identifier for each of the sensor data, wherein the data source identifier comprises a data source type identifier corresponding to a data source type from which the sensor data is received, wherein a first data source type identifier corresponds to the first data source type and a second data source type identifier corresponds to the second data source type,
means for compiling a dataset to be associated comprising as elements newest sensor data received,
a data association module (30) adapted to perform data association on the dataset to be associated.

13. The computer system according to claim 12, further comprising a sampler module (28) as the means for compiling a dataset to be associated.

14. The computer system according to claim 12, further comprising a matching module (42) adapted to
matching an element of the dataset having the first data source type identifier with each element of the dataset having the second data source type identifier, and/or
matching remaining elements of the dataset having the second data source type identifier with each other and forming group(s) of elements of the dataset, wherein each group belongs to a same entity.

15. The computer system according to claim 12, further comprising a mapping cache (34) for storing an entity selection set.

16. The computer system according to claim 15, further comprising a data fusion module (38), for combining sensor data of the entity selection set.

17. A non-transitory computer program product comprising instructions which, when the program is executed by a computer, cause the computer to carry out the method of claim 1.

18. A non-transitory computer readable medium comprising instructions which, when executed by a computer, cause the computer to carry out the method of claim 1.
